(19) United States
(12) Patent Application Publication
(10) Pub. No.: US 2026/0048726 A1
(43) Pub. Date: Feb. 19, 2026

(54) Truck Trailer Interface

(71) Applicant: KNORR-BREMSE Systeme fuer Nutzfahrzeuge GmbH, Muenchen (DE)

(72) Inventors: Christian STAAHL, Muenchen (DE); Martin MEDERER, Muenchen (DE)

(21) Appl. No.: 19/101,623

(22) PCT Filed: Aug. 25, 2023
(86) PCT No.: PCT/EP2023/073399

§ 371 Date: Feb. 6, 2025

(30) Foreign Application Priority Data
Sep. 15, 2022 (GB) 2213584.2

(51) Int. Cl. B60T 13/26; B60T 7/20; B60T 13/66; B60T 13/68; B60T 17/22

(52) U.S. Cl. CPC B60T 13/263; B60T 7/20; B60T 13/662; B60T 13/683; B60T 17/22; B60T 2270/402; B60T 2270/403

(57) ABSTRACT

A pneumatic brake system for a towing and towed vehicle includes means for supplying a supply pressure and means for supplying a control pressure to the towed vehicle. An electrical connection is provided between respective ECUs on the towing and towed vehicles which are able to exchange information and determine whether the brake system in both towed and towing vehicle is compatible with an electronic brake signal and whether the brake system is compatible with secondary supply pressure being applied via a control pressure line. If both conditions are fulfilled, the brake system actuates a switching device or devices on the towing and towed vehicles to direct air from the means for supplying a control pressure to a second pneumatic supply circuit in the towed vehicle.

### BACKGROUND AND SUMMARY

The invention relates to a pneumatic interface between a trailer and a towing vehicle, in particular, but not exclusively, an interface between a heavy truck and trailer.

In view of the increasing digitization and automation of motor vehicles towards highly automated driving, functions traditionally undertaken by the driver are at least partially replaced by vehicle automation systems. Such automation requires an integration of additional functions, sensors and other electrical subsystems. It is expected that as vehicles are automated, general acceptance of or tolerance towards road accidents by users and legislators will drop significantly, as road fatalities and injuries caused by machines will not be as accepted as driver error.

In addition to this, with the increasing worth of the trailer, the availability of the trailer will be ever so more important to the operator. This means that compared to known vehicles, there is pressure to increase the level of safety, ensure the availability and performance of critical functions and to reduce the error rate.

In order to operate in a commercially viable way, logistics operators need to be able to use their trailers in a very flexible way. One very important part of that flexibility is the possibility to pair a trailer with just about any towing vehicle in the fleet. The requirements associated are referred to as compatibility and interoperability within the industry and apply to coupling equipment, pneumatic and electrical connectors as well as communication protocols.

These requirements lead to a certain degree of sluggishness with regard to technological progress in the areas mentioned above. This is a result of the different age of vehicles in a fleet and the necessity of compatibility and interoperability between all of them.

One example of this is the current design of pneumatic coupling heads. Two coupling heads exist, a red one for supply pressure and a yellow one for brake or control pressure. Supply pressure is normally fed from the third pneumatic circuit in a towing vehicle, with the first and second circuits being used for brake circuits 1 and 2 respectively. This design has proven to be very robust all over the world. In Europe there is a form of redundancy for the brake pressure signal as it is also sent via CAN message on the ISO7638 connector. For supply pressure however, there is no redundancy and a rupture or disconnect of the supply line or a fault in the associated pneumatic circuit in the towing vehicle will trigger the emergency brake function. This will cause automatic braking of the towed vehicle on some or all wheels.

In an automated driving use case this would force the vehicle combination to an uncontrolled and immediate stop.

A pragmatic approach would be to simply add another supply line. However this is very costly, as new vehicles would require the new interface and additionally the old ones as well if the compatibility and interoperability is to be maintained. Such interface additions have been offered in Europe in the past, e.g. duomatic connectors. However the relatively low installation rate confirms the price sensitivity of the market.

The present invention therefore seeks to provide redundancy in the pneumatic supply line from a truck to a trailer.

This is achieved in accordance with the features of the independent claim(s).

The concept underlying the invention is to use the existing two pneumatic coupling heads to provide a redundant pneumatic supply from two separate circuits in the towing vehicle. This can apply not only for connections between trucks and trailers but in the more general sense between towing vehicles (which can also be a trailer in case of multi trailer or road train combinations) and towed vehicles.

Preferred aspects are recited in the dependent claims.

Exemplary embodiments of the invention will now be described in greater detail with reference to the drawings.

### BRIEF DESCRIPTION OF THE DRAWINGS

FIG. 1 shows schematically the head board of semi-trailer;

FIG. 2 shows a first embodiment of the pneumatic connections between a towing and towed vehicle;

FIG. 3 shows a second embodiment of the pneumatic connections between a towing and towed vehicle;

FIG. 4 shows a third embodiment of the pneumatic connections between a towing and towed vehicle; and

FIG. 5 shows a further embodiment with more than one electrical connection.

### DETAILED DESCRIPTION OF THE DRAWINGS

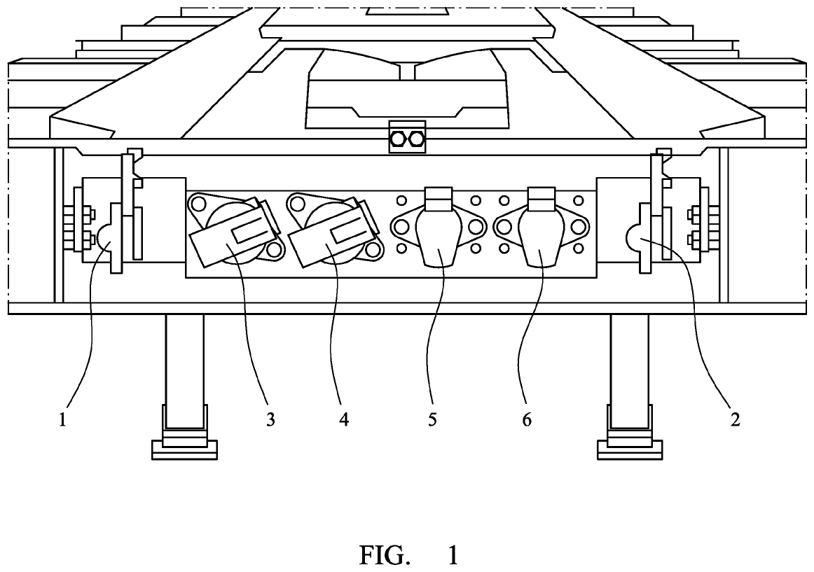

FIG. 1 shows schematically the head board of semi-trailer in accordance with European standards having a red line pneumatic connection 1 for emergency braking and a yellow line pneumatic connection 2 for service braking. Four electrical connectors are arranged between the pneumatic connections, namely a 15 pin ISO 12098 connector 3 with CAN bus, a 7 pin ISO 7638-01 connector 4 for EBS functionality, a 7 pin ISO 1185 connector 5 and a 7 pin ISO 3731 connector 6.

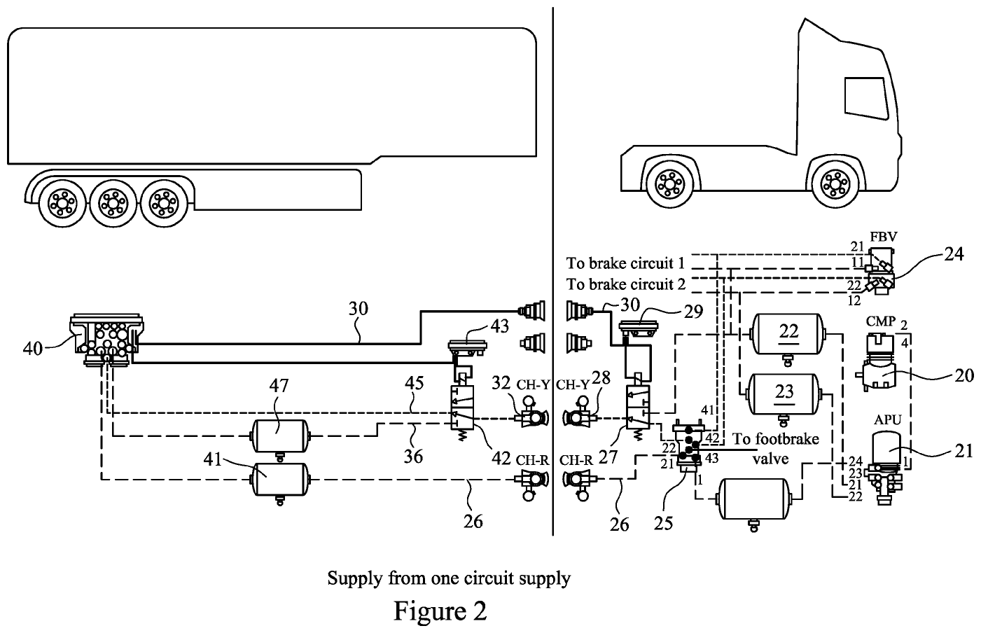

FIG. 2 shows a first embodiment, in which an electrical connection between the towing and towed vehicle can be used to convey the brake pressure signal in a digital or analog way.

In the embodiment of FIG. 2, the towing vehicle is shown as a truck, for which the brake system is shown schematically. The truck brake system comprises a compressor 20 connected to an air processing unit 21, which supplies air to first and second reservoirs 22, 23. The outlet of each reservoir 22,23 is pneumatically connected to the foot brake valve 24 and provides the supply pressure to first and second brake circuits on the truck. The air processing unit 21 is further connected to a third reservoir, the output of which is connected to a trailer control module 25. The trailer control module receives inputs from the first and second brake circuits and is pneumatically connected to the trailer via the (red) supply line 26.

The trailer control module 25 is further pneumatically connected to solenoid 27 providing a (yellow) control line pressure connection 28 to the trailer. The solenoid 27 receives a further pneumatic input from the reservoir 22. An ECU 29 is provided which controls the operation of the solenoid 27 and is provided with an electrical signal on line 30.

The trailer brake system is also shown schematically, with a trailer brake module 40, which receives a supply pressure via line 26 from a first trailer reservoir 41. The trailer brake module 40 also receives an electrical signal on the line 30, which is connected to the truck via the standards compliant connectors 32.

A solenoid 42 is provided, which is controlled by ECU 43 which receives control signals via line 44 from the trailer brake module. The solenoid has a pneumatic connection to the control line 28 and has control line 45 and supply line 36 outputs to the trailer brake module. A further reservoir 47 is provided in line 36.

The existence of this electrical signal on line 30 means that the brake pressure signal on the yellow coupling head 28 has redundancy. This pneumatic connection can now be used to provide a second air supply to the trailer or towed vehicle braking system. In the towing vehicle, the ECU 29 is connected to the ECU 43 in the towed vehicle. The two ECUs can exchange information and determine:
a. Is the brake system in both vehicles compatible with an electronic brake signal?
b. Is the vehicle compatible with receiving/providing secondary supply pressure via the yellow coupling head?

If the answer to both queries is yes, the vehicles can initiate a pneumatic switching device:
to provide air supply from the brake circuit supply 1 or 2 to the yellow coupling head in the towing vehicle, and
redirect the air from the yellow coupling head to a second pneumatic circuit in the towed vehicle

The ECUs in the FIG. 2 may be standalone ECUs or their function may also be integrated in the brake system ECU, a vehicle control ECU or any other existing ECU in the towed/towing vehicle.

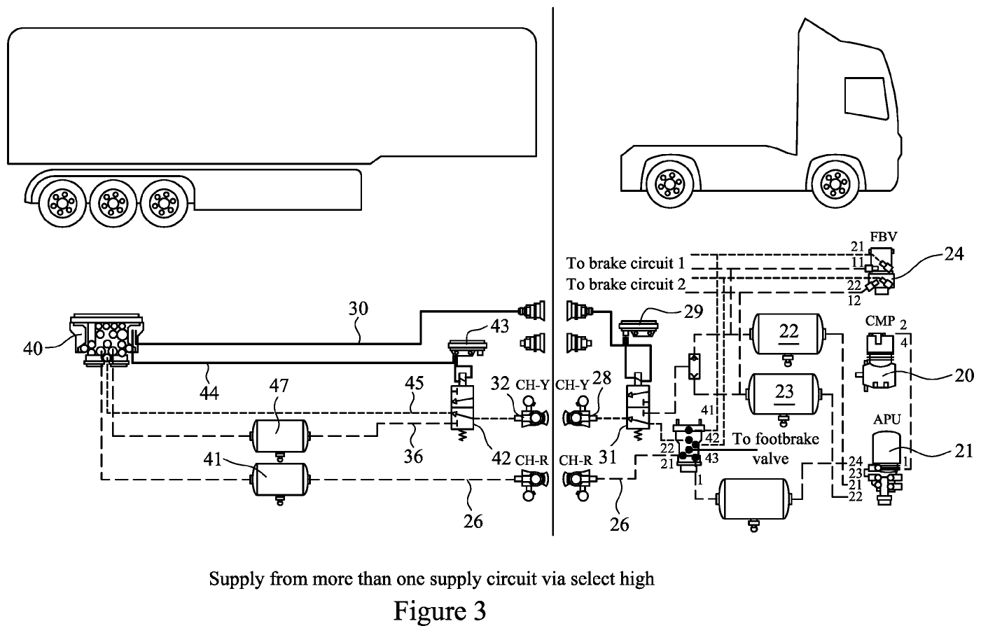

In FIG. 3, like parts are shown with like numbers. In this embodiment, the supply to the valve 27 is switchable between the first and second brake circuits. This switching device is shown as a selection valve 31 such as a select high valve or double-check valve. However it can be any type of valve or redirection mechanism that serves the purpose described above. As with the embodiment of FIG. 2, in the event of failure, or any other case where it is deemed required that the yellow coupling head convey the brake pressure signal, the switching mechanism can revert to its default position so that the yellow coupling head on the towing vehicle is once again connected to the brake pressure signal coming from the brake system and the coupling head on the towed vehicle is connected to the brake system.

This embodiment is the same as the first embodiment except when it comes to the pneumatic supply being fed to the yellow coupling head. In this embodiment at least two pneumatic supply circuits are used and they are combined with select high valves. FIG. 3 shows this for two circuits, brake circuit supply 1 and 2, but additional circuits could be used. The select high valves can either be cascaded or an integrated version that supports more inputs.

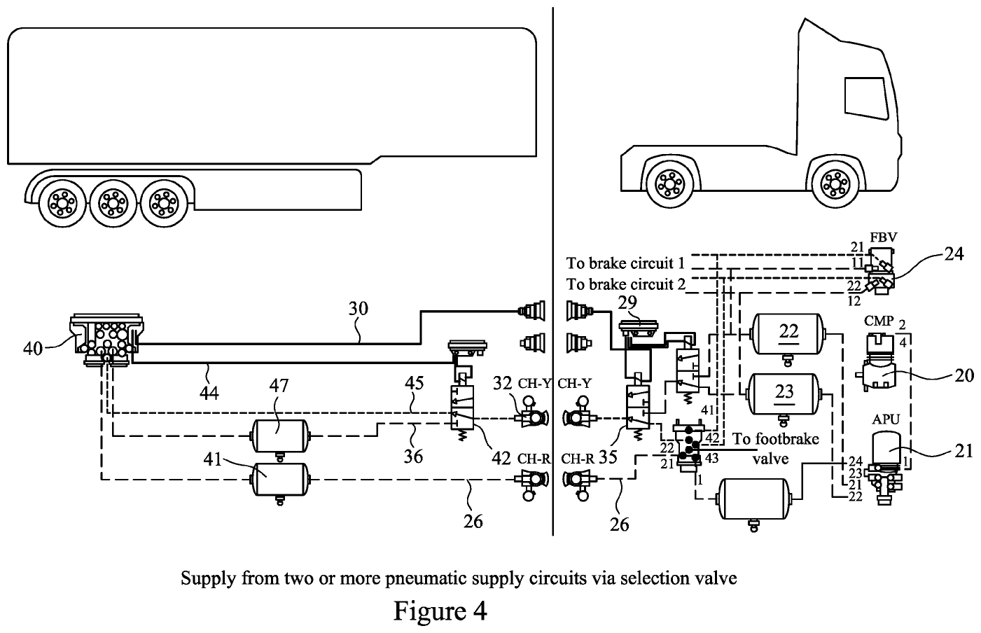

FIG. 4 shows a further embodiment in which brake pressure supply is from more than one supply circuit via a 3/2 valve 35. This embodiment also uses multiple supply circuits to feed to the yellow coupling head. The main difference to the second embodiment is that the supply source can be actively selected using information gathered in the towed vehicle and/or received from the towing vehicle. The selection can be made by the ECU 29 or another one that is connected to it. In FIG. 4 the selection valve is an electrically controlled 3/2 valve. It may be any other valve or device that serves this purpose.

The selection/switching devices illustrated in FIGS. 2 to 4, may be standalone components as illustrated. They may also be integrated in existing components, e.g. in the trailer control module in the towing vehicle or in the brake system in towing/towed vehicle.

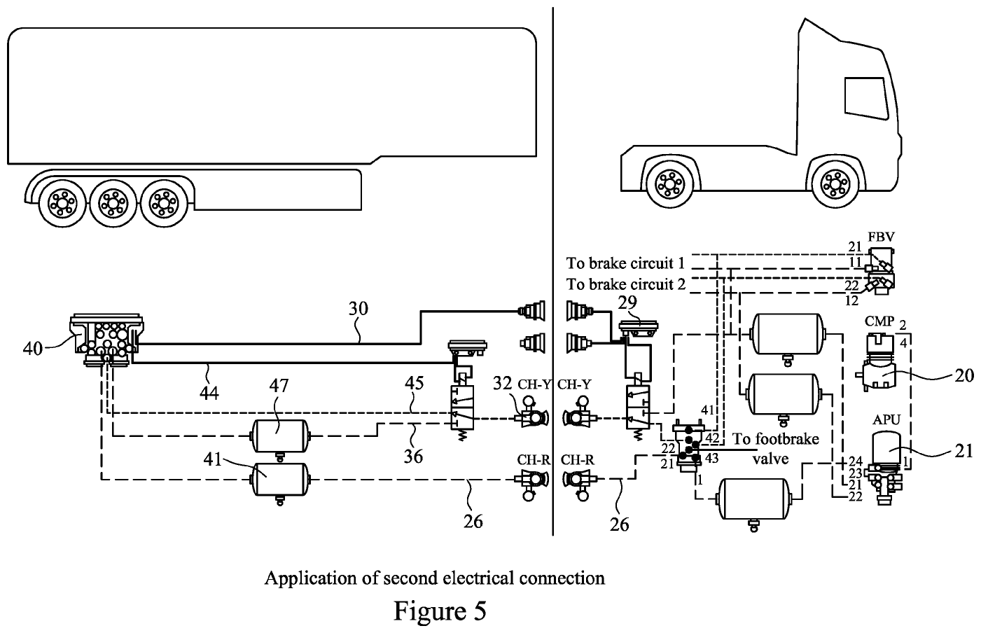

FIG. 5 shows a further embodiment with more than one electrical connection which is used to facilitate the communication of the ECUs in the towing and towed vehicle. FIG. 5 shows this for the first embodiment but it is compatible with all design variants.

In the case of each embodiment, in a first mode of operation, the ECU 29 or equivalent checks whether there is a corresponding capability on the trailer when the truck ignition is turned on after the trailer is connected to the truck. In this mode, the supply would switch to a redundant supply mode as soon as it determines both vehicles to be compatible. It would switch back to conventional mode if a fault that renders the towed/towing vehicle incompatible with redundant supply is detected.

An alternative mode would default to the conventional mode and only switch control pressure to supply pressure if a fault in the primary supply on the red coupling head is detected.

At this time, the standards in force are ISO 1185:2003 ISO 7638-1/2:2018, ISO 11992:2021 and ISO12098:2020 and SAE 560:2020.

1.-8. (canceled)

9. A pneumatic brake system for a towing and towed vehicle, comprising:
means for supplying a supply pressure to the towed vehicle;
means for supplying a control pressure to the towed vehicle; and
an electrical connection provided between the towing and towed vehicles;
a respective ECU for each of the towing and towed vehicles, the respective ECUs being configured to exchange information and determine:
a first condition whether the brake system in both the towed and towing vehicle is compatible with an electronic brake signal and a second condition whether the brake system is compatible with secondary supply pressure being applied via the means for supplying a control pressure, and
in an event that both conditions are fulfilled, the brake system actuates a switching device or devices to direct air from the means for supplying a control pressure to a second pneumatic supply circuit in the towed vehicle.

10. The pneumatic brake system according to claim 9, wherein
the means for supplying a control pressure is switchable so as to receive a brake pressure signal or a supply pressure from the towed vehicle brake system.

11. The pneumatic brake system according to claim 9, wherein the switching device is an electrically or pneumatically controllable 3/2 valve.

12. The pneumatic brake system according to claim 9, wherein pressure is supplied from more than one supply circuit via a selection valve.

13. The pneumatic brake system according to claim 12, wherein
the supply circuit is actively selectable using information gathered in the towed vehicle and/or received from the towing vehicle.

14. The pneumatic brake system according to claim 9, wherein
the ECU on the towing vehicle checks whether there is a corresponding capability on the towed vehicle when an ignition on the towing vehicle is turned on after the towed vehicle is connected to the towing vehicle.

15. The pneumatic brake system according to claim 14, wherein the supply pressure switches when it is determined that the towed and towing vehicle are compatible.

16. The pneumatic brake system according to claim 15, wherein the supply pressure only switches when a fault in a primary supply is detected.
